(19) United States
(12) Patent Application Publication
(10) Pub. No.: US 2015/0016637 A1
(43) Pub. Date: Jan. 15, 2015

(54) METHOD AND APPARATUS TO COUPLE AN AUDIO SOURCE TO A LEGACY AUDIO SYSTEM

(71) Applicant: Matthew P. McClurg, Huntertown, IN (US)

(72) Inventor: Matthew P. McClurg, Huntertown, IN (US)

(21) Appl. No.: 14/199,454

(22) Filed: Mar. 6, 2014

Related U.S. Application Data
(60) Provisional application No. 61/846,316, filed on Jul. 15, 2013.

(51) Int. Cl. H04R 3/00

(52) U.S. Cl. CPC H04R 3/00
USPC 381/123

(57) ABSTRACT

An audio system including a legacy radio system having a radio and a set of speakers, and an audio selection system electrically coupled between the radio and the set of speakers. The audio selection system is configured to detect a signal containing audio information, with the signal not coming from the radio. The audio selection system is further configured to electrically disconnect the set of speakers from the radio and to route the audio information to the set of speakers upon detection of the signal.

### CROSS REFERENCE TO RELATED APPLICATIONS

This is a non-provisional application based upon U.S. provisional patent application Ser. No. 61/846,316, entitled “ METHOD AND APPARATUS TO COUPLE AN AUDIO SOURCE TO A LEGACY AUDIO SYSTEM”, filed Jul. 15, 2013, which is incorporated herein by reference.

### BACKGROUND OF THE INVENTION

1. Field of the Invention

The present invention relates to audio systems, and, more particularly, to a coupling of a digital signal source to a legacy radio system.

2. Description of the Related Art

In older audio systems there are often limited ways in which you can add audio choices. If an audio source has audio input ports then an audio signal can be connected and the signal can be selected to play on the system speakers.

Many audio sources were built without contemplating alternate audio sources being directed to the speakers. For example, restored automobiles are often painstakingly restored with all, or as much as is possible, original equipment so that authenticity can be maintained. In this example let's consider a radio system, which is entirely analog and has no capability of detecting a modern day audio signal sent by a digital device. Even if the audio signal was available as at the end of a wire the radio has no ports into which to direct the audio signal.

To change out the legacy radio with a more modern audio device is unthinkable, since it would destroy the look and feel of the restored system. Even if the legacy radio functions poorly or even not at all, the look and feel of the original device is highly desirable.

One problem associated with prior art is the inability to offer a convenient solution that allows modern functionality, but maintains the original look and feel of a legacy system.

What is needed in the art is a convenient out of sight solution to allow an audio source, such as that associated with a Bluetooth device, to be able to convey the audio to the legacy speakers.

### SUMMARY OF THE INVENTION

The present invention provides a system and a method of coupling a modern audio source to a legacy radio system.

The invention in one form is directed to an audio system including a legacy radio system having a radio and a set of speakers, and an audio selection system electrically coupled between the radio and the set of speakers. The audio selection system is configured to detect a signal containing audio information, with the signal not coming from the radio. The audio selection system is further configured to electrically disconnect the set of speakers from the radio and to route the audio information to the set of speakers upon detection of the signal.

The invention in another form is directed to an audio control system for use with a legacy radio system having a radio and a set of speakers. The audio control system includes an audio selection system electrically coupled between the radio and the set of speakers. The audio selection system is configured to detect a signal containing audio information, with the signal not coming from the radio. The audio selection system is further configured to electrically disconnect the set of speakers from the radio and to route the audio information to the set of speakers upon detection of the signal.

The invention in yet another form is directed to a method of using a digital audio source with a legacy radio system having a radio and a set of speakers. The method includes the steps of: electrically coupling an audio selection device between the radio and the set of speakers; detecting a signal containing audio information with the audio selection device, with the signal not coming from the radio; electrically disconnecting the set of speakers from the radio; and routing the audio information to the set of speakers upon detection of the signal.

An advantage of the present invention is that the audio selector can be inserted into the wiring of a legacy radio system and allow the playing of streaming audio from a Bluetooth device on the legacy speaker system.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematical view of an embodiment of an audio selector according to the present invention;

FIG. 2 is a schematic view of an embodiment of an audio selector for a stereo system according to the present invention;

FIG. 3 is a schematic view of another embodiment of an audio selector for a quadraphonic system according to the present invention;

FIG. 4 is a schematic view of yet another embodiment of an audio selector for a quadraphonic system using an AC power source according to the present invention;

FIG. 5 is a schematic view of another embodiment of an audio selector for a quadraphonic system of the present invention using a power supply that obtains power from an output of a legacy radio system;

FIG. 6 is a schematic view of yet another embodiment of an audio selector for a quadraphonic system using simplified power system; and

FIG. 7 is a schematical representation of an embodiment of a method of providing an audio signal to a legacy radio system, of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

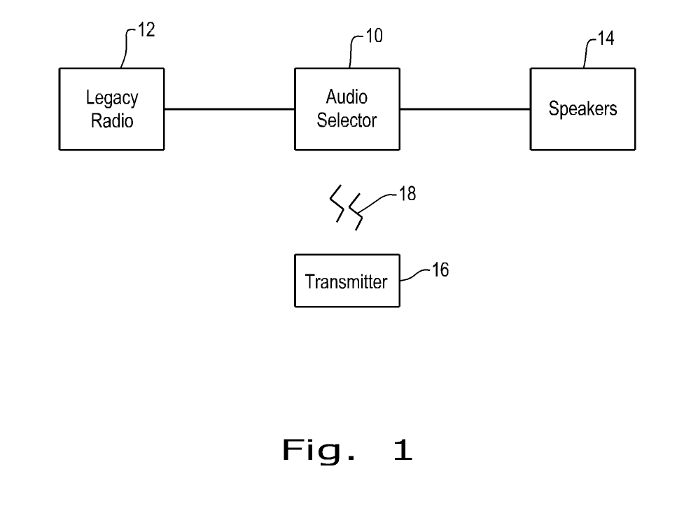

Referring now to the drawings, and more particularly to FIG. 1 there is shown in a schematic form the connection of an audio selector 10, also known as an audio insertion device 10, to a legacy radio 12, and speakers 14. A transmitter 16, which may be in the form of a Bluetooth device 16, produces a signal 18 having audio information therein. Signal 18 is detected by audio selector 10, which in response to the detection, electrically disconnects legacy radio 12 from speakers 14 and routes the audio information from signal 18 to speakers 14. Legacy radio 12 has no audio signal input ports. Nor does legacy radio 12 have an ability to detect signal 18.

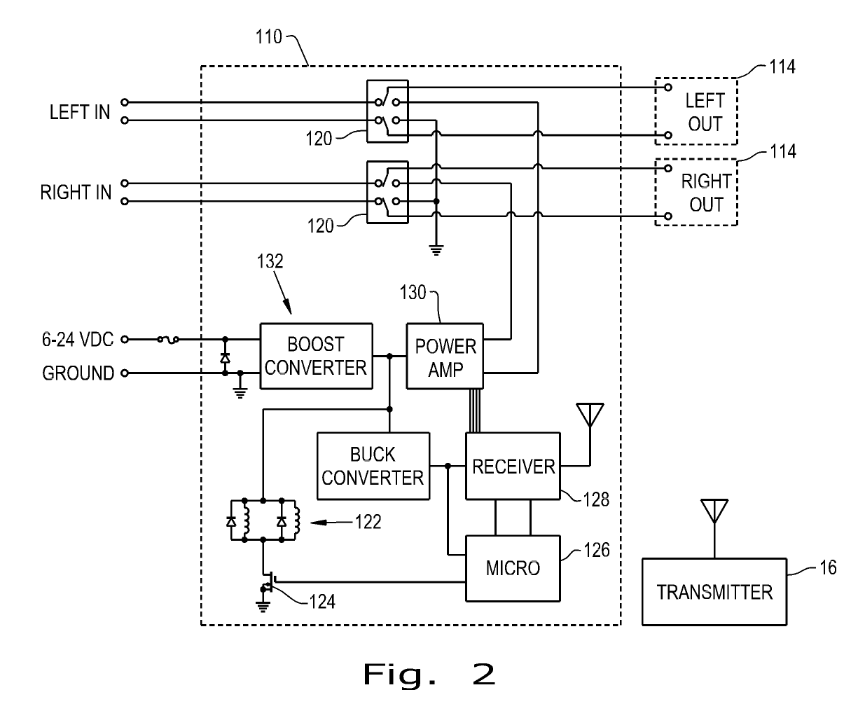

Now, additionally referring to FIGS. 2-6, there are shown embodiments of the present invention, in the form of an audio insertion device 110, 210, 310, 410, 510 which allows an audio source, such as a Bluetooth device 16, to be coupled to legacy audio system 12. The addition of multiples of 100 to a reference number is to indicate that the items are similar, yet of different embodiments of the present invention, and that the features of an element are similar or even identical to an element having a different multiple of 100 as the first digit of the reference number.

FIG. 2 illustrates the use of audio insertion device 110 relative to a two speaker stereo system 114 that may be installed in a classic automobile. The audio output of the legacy audio system 12 is connected to audio insertion device 110 at the “left in” and “right in” as shown in the upper left of FIG. 2. Speakers 114 of the legacy system are connected as illustrated on the right of audio insertion device 110.

Relays 120 are shown as double pole—double throw relays and are shown as being connected such that the audio signals from the legacy audio system 12 are being used to drive the legacy speakers 114. Coils 122 of relays 120 (although show schematically separate from relays 120 it is understood that coils 122 are integral with relays 120) are energized by the passing of current when transistor 124 receives a signal from microcontroller 126 causing transistor 124 to be conductive. Microcontroller 126 may be in the form of a microprocessor 126 or any other control circuitry. Microcontroller 126 interfaces with a receiver 128, which may be in the form of a Bluetooth module 128, which attempts to receive an authenticated Bluetooth signal from Bluetooth device 16. When no signal is being received from Bluetooth device 16 audio from the legacy system 12 is used to drive the legacy speakers 114.

When Bluetooth device 16 sends signal 18 containing audio information, as in streaming audio, to Bluetooth module 128, Bluetooth module 128 sends a signal to microcontroller 126 indicating that a valid audio signal is being received. In turn microcontroller 126 sends a signal to transistor 124, the signal may be in the form of a sustained voltage level, thereby causing transistor 124 to conduct allowing current to flow through coils 122. When current is supplied to coils 122 then relays 120 change their contact positions to direct audio supplied from power amplifier 130 to the speakers 114. Microcontroller 126 controls the timing of the energizing of coils 122 to allow the audio connection to be established before sending amplified audio signals to speakers 114. When no streaming audio is available from Bluetooth device 16 then speakers 114 are connected to the legacy audio source 12.

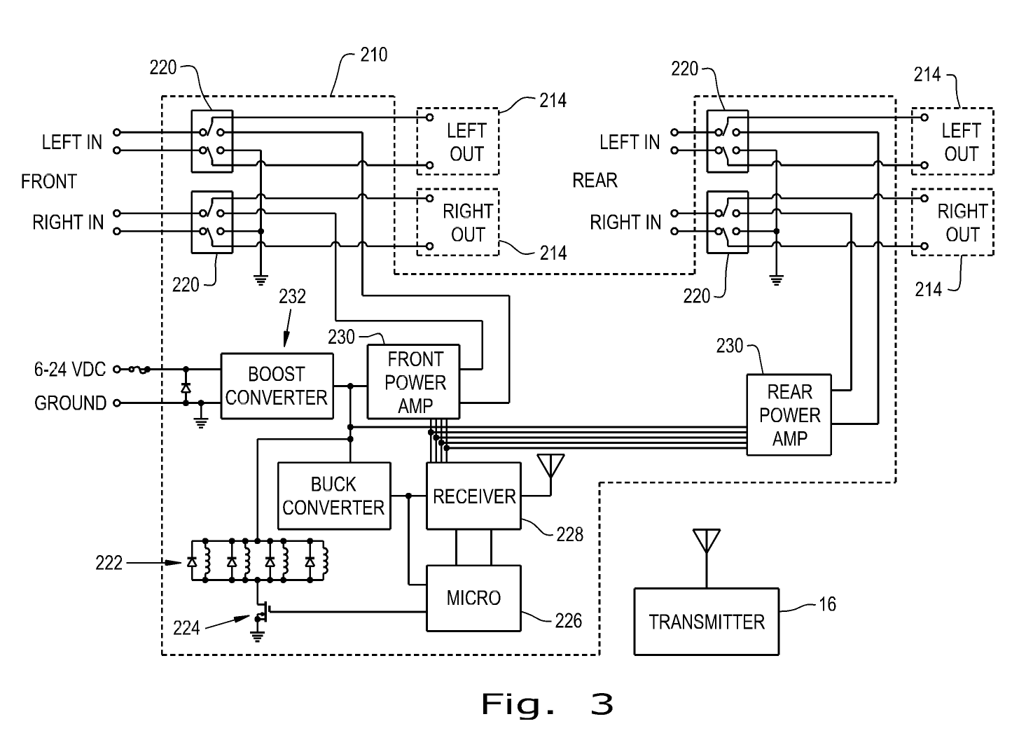

In FIG. 3 a system similar to FIG. 2 is illustrated with four input audio channels, which are handled with twice as many relays 220 as were used in the embodiment illustrated in FIG. 1. The function of amplifier 130 is carried out with two amplifiers 230, each supplying amplified audio to two speakers 214.

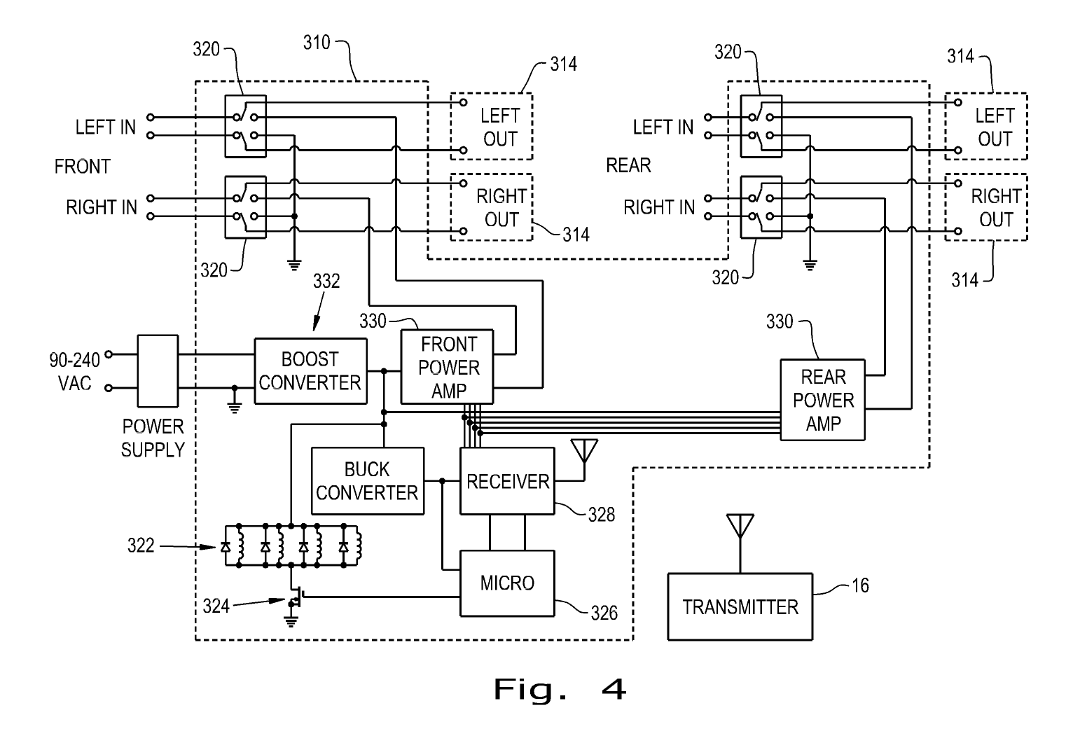

The embodiment illustrated in FIG. 4 is similar to the embodiment of the present invention shown in FIG. 3, with the power supply being from an AC source, to illustrate that the present invention can be used with legacy equipment in a non-vehicular application, such as in a home entertainment center.

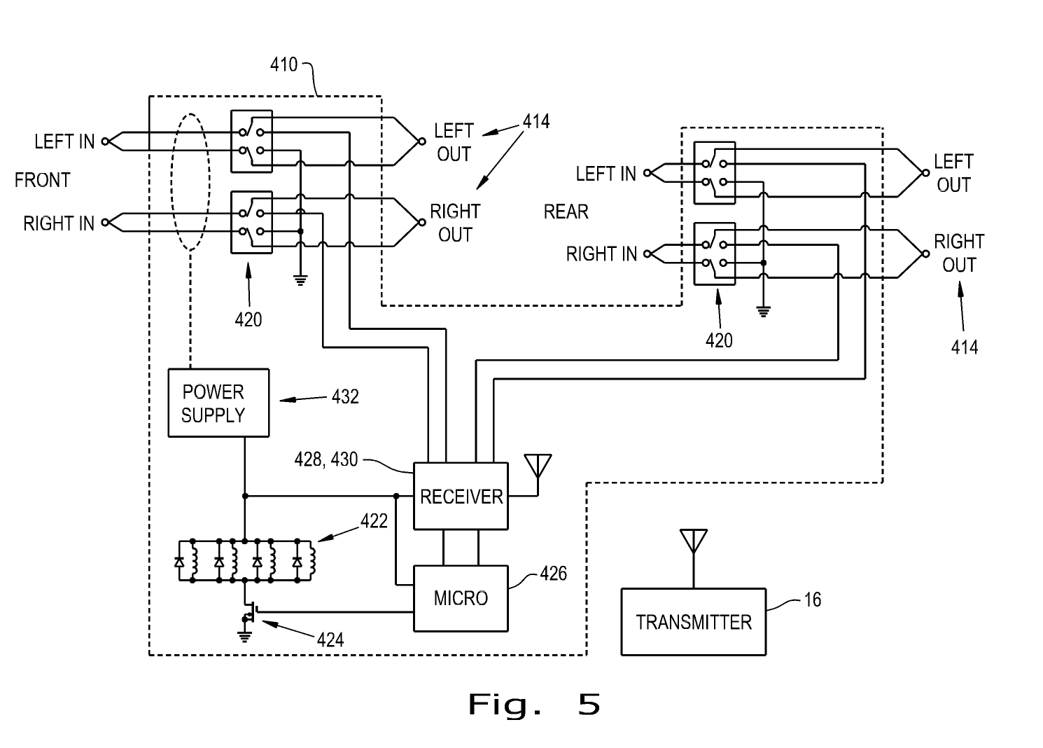

Now, additionally referring to FIG. 5, there is illustrated an audio selector 410 in which a power supply 432 obtains energy from the output of legacy radio 12, to illustrate a power source that is not directly connected to the electrical power system of a vehicle, or another source. Also the amplification features of the power amplifier(s) is incorporated into receiver 428.

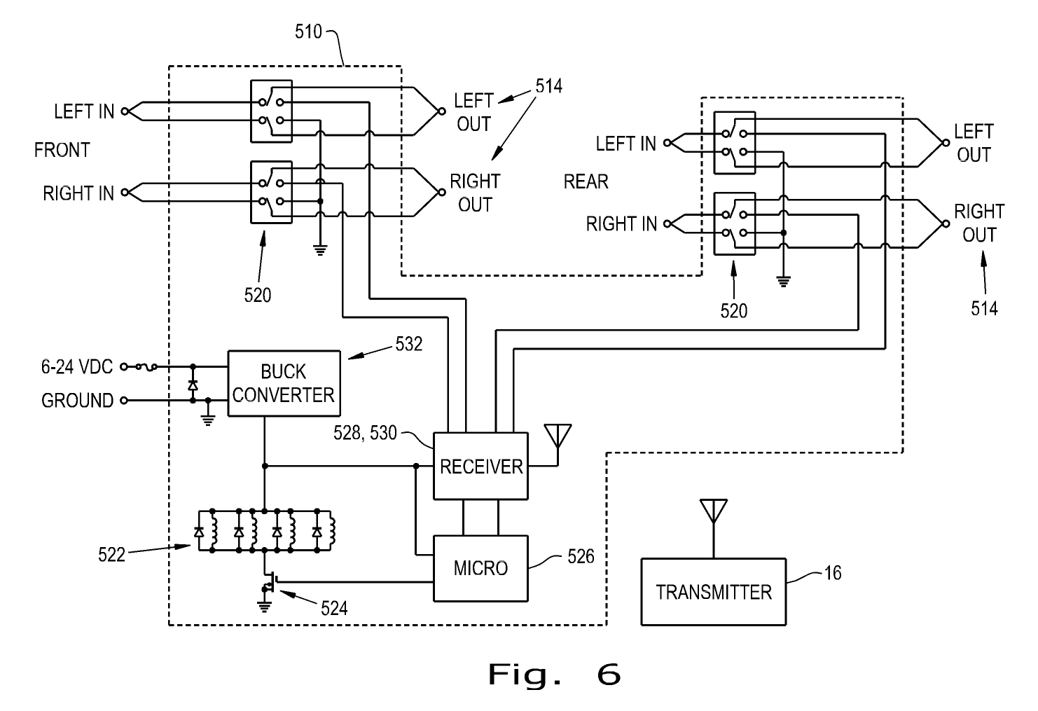

Now, additionally referring to FIG. 6, there is illustrated an audio selector 510, which is similar to FIG. 5, with the electrical power being supplied from an external DC power source.

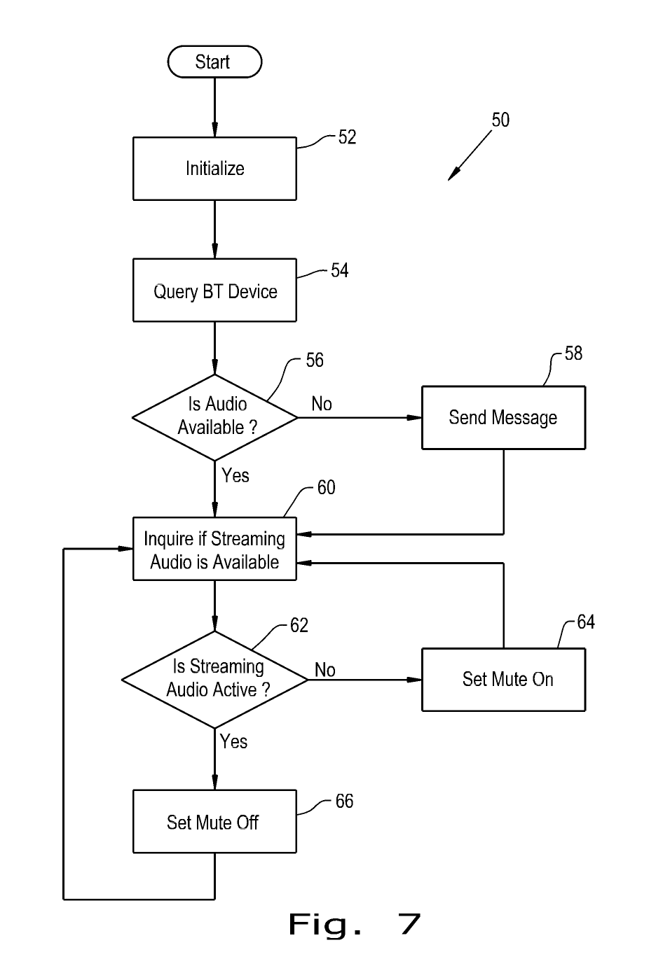

Now, additionally referring to FIG. 7, there is illustrated a method 50 of steps taken by microcontroller 126. At step 52, the ports of microcontroller 126 are initialized, the mute is turned on and the relays 120 are set to pass the legacy signal to speakers 114. Further the communication protocol is set. At step 54, a query is sent to Bluetooth module 128 with the response received at step 56 determined to see if audio is available. If the answer is NO at step 56, then method 50 proceeds to step 58, where a message is sent indicating no audio is available. At step 60 an inquiry is made to Bluetooth module 128 to see if streaming audio is active, which is tested at step 62. If the answer is NO, then at step 64 the mute is turned on and the relays 120 are set to pass the legacy audio to the legacy speakers 114. If the answer is YES then at step 66 the mute is turned off and relays 120 are activated to thereby connect legacy speakers 114 to power amp 130 (or receiver 428 as appropriate) so that the streaming audio from Bluetooth device 16 will be sent to those speakers, thereby cutting off the audio output from the legacy audio source 12. Although not illustrated it is also contemplated that the system may switch the audio output of the legacy source to an appropriate electrical load to dissipate the signal sent therefrom.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An audio system, comprising:
a legacy radio system having a radio and a set of speakers; and
an audio selection system electrically coupled between said radio and said set of speakers, said audio selection system being configured to detect a signal containing audio information, said signal not coming from said radio, said audio selection system being further configured to electrically disconnect said set of speakers from said radio and to route said audio information to said set of speakers upon detection of said signal.

2. The audio system of claim 1, wherein said radio has no audio signal input ports.

3. The audio system of claim 2, wherein said audio selection system is further configured to electrically reconnect said set of speakers to said radio upon no longer detecting said signal.

4. The audio system of claim 3, wherein said set of speakers is two speakers.

5. The audio system of claim 3, wherein said set of speakers is four speakers.

6. The audio system of claim 1, wherein said radio is an analog radio.

7. The audio system of claim 1, further comprising a transmitter configured to generate said signal, said transmitter being located proximate to said audio selection system.

8. The audio system of claim 7, wherein said transmitter is a Bluetooth device.

9. An audio control system for use with a legacy radio system having a radio and a set of speakers, the audio control system comprising:
an audio selection system electrically coupled between said radio and said set of speakers, said audio selection system being configured to detect a signal containing audio information, said signal not coming from said radio, said audio selection system being further configured to electrically disconnect said set of speakers from said radio and to route said audio information to said set of speakers upon detection of said signal.

10. The audio control system of claim 9, wherein the radio has no audio signal input ports.

11. The audio control system of claim 10, wherein said audio selection system is further configured to electrically reconnect the set of speakers to the radio upon no longer detecting said signal.

12. The audio control system of claim 11, wherein the set of speakers is two speakers.

13. The audio control system of claim 11, wherein the set of speakers is four speakers.

14. The audio control system of claim 9, wherein the radio is an analog radio.

15. The audio control system of claim 9, further comprising a transmitter configured to generate said signal, said transmitter being located proximate to said audio selection system.

16. The audio control system of claim 15, wherein said transmitter is a Bluetooth device.

17. A method of using a digital audio source with a legacy radio system having a radio and a set of speakers, the method comprising the steps of:
electrically coupling an audio selection device between the radio and the set of speakers;
detecting a signal containing audio information with said audio selection device, said signal not coming from the radio;
electrically disconnecting the set of speakers from the radio; and
routing said audio information to the set of speakers upon detection of said signal.

18. The method of claim 17, wherein the radio has no audio signal input ports.

19. The method of claim 18, further comprising the step of electrically reconnecting the set of speakers to the radio upon no longer detecting said signal.

20. The method of claim 19, further comprising the step of generating said signal with a transmitter located proximate to said audio selection system, the transmitter getting the audio information from the digital audio source.
